(19) United States
(12) Patent Application Publication
(10) Pub. No.: US 2013/0155435 A1
(43) Pub. Date: Jun. 20, 2013

(54) MULTI-FUNCTION PRINTER AND INTUITIVE DOCUMENT ALIGNMENT METHOD THEREOF

(71) Applicant: Wei-Lun Ma, New Taipei City (TW)

(72) Inventor: Wei-Lun Ma, New Taipei City (TW)

(73) Assignees: CAL-COMP ELECTRONICS & COMMUNICATIONS COMPANY LIMITED, New Taipei City (TW); KINPO ELECTRONICS, INC., New Taipei City (TW)

(21) Appl. No.: 13/527,602

(22) Filed: Jun. 20, 2012

(30) Foreign Application Priority Data
Dec. 15, 2011 (TW) 100146549

(51) Int. Cl. G06K 15/02

(52) U.S. Cl. 358/1.13

(57) ABSTRACT

A multi-function printer (MFP) and an intuitive document alignment method thereof are provided. The provided method includes: installing a first touch strip light-emitting diode (LED) module on a first document alignment boundary of a scan platform of the MFP, and installing a second touch strip LED module on a second document alignment boundary of the scan platform of the MFP, where the first and the second document alignment boundaries are perpendicularly intersected; and controlling, when a top cover of the MFP is opened, the first and the second touch strip LED modules to respectively generate a first and a second predetermined lighting lines, where a default scan area can be defined by the first and the second lighting lines.

### CROSS-REFERENCE TO RELATED APPLICATION

This application claims the priority benefit of Taiwan application serial no. 100146549, filed on Dec. 15, 2011. The entirety of the above-mentioned patent application is hereby incorporated by reference herein and made a part of this specification.

### BACKGROUND OF THE INVENTION

1. Field of the Invention

The present invention relates to a multi-function printer and an intuitive document alignment method thereof.

2. Description of Related Art

With the advent of information society, office automation devices such as a scanner, a photocopy (copy) machine and a printer, etc. are generally set in an office, and a user can use these office automation devices to implement document processing tasks. It should be noticed that a lot of space is occupied when the aforementioned office automation devices are simultaneously equipped in the office. Therefore, a multi-function printer (MFP) integrated with a scan function, a photocopy (copy) function and a print function, etc. is developed.

The current MFP can support scanning or photocopying with various types of standard size documents, for example, A3, A4, A5, B4, B5, B6 documents and letter, etc., but most users may be affected by the over-complicated alignment marks (i.e., a plurality of scales on two document alignment boundaries of the scan platform) when using the MFP to perform the document scanning or photocopying, such that the users may have trouble to find the correct document size marks in a short time.

Furthermore, all scan areas of the current MPF are defined by the standard size documents, so once the size of the document to be scanned or photocopied does not match the standard size, for example, the size of a certain document is between A3 and A4 documents, the MFP would perform scanning on the document by using the scan area corresponding to the A3 document. Therefore, the image obtained by scanning is over sized, and thus the memory is wasted and the scanning time is extended.

### SUMMARY OF THE INVENTION

Accordingly, the present invention is directed to a multi-function printer (MFP) and an intuitive document alignment method thereof, which let users easily see the correct position for the document once they open the top cover of the MFP, and even allow users to set any scan areas for standard or non-standard size documents to suit their own needs.

An exemplary embodiment of the present invention provides an MFP including a top cover, a control unit, a scan platform, a first touch strip light-emitting diode (LED) module and a second touch strip LED module. The control unit is configured to be served as an operation core of the MFP. The scan platform has a document alignment original point, a first document alignment boundary which originates at the document alignment original point and extends along a first direction, and a second document alignment boundary which originates at the document alignment original point and extends along a second direction, wherein the first direction and the second direction are perpendicularly intersected. The first touch strip LED module is coupled with and controlled by the control unit, and is installed on the first document alignment boundary. The second touch strip LED module is coupled with and controlled by the control unit, and is installed on the first document alignment boundary. Accordingly, the control unit is further configured to control the first and the second touch strip LED modules to respectively generate a first predetermined lighting line and a second predetermined lighting line in response to the top cover being opened, and the first and the second predetermined lighting lines define a default scan area.

Another exemplary embodiment of the present invention provides an MFP including a top cover, a control unit, a scan platform, a first touch strip LED module and a second touch strip LED module. The control unit is configured to be served as an operation core of the MFP. The scan platform has a first document alignment boundary and a second document alignment boundary which are perpendicular intersected. The first touch strip LED module is coupled with and controlled by the control unit, and is installed on the first document alignment boundary. The second touch strip LED module is coupled with and controlled by the control unit, and is installed on the second document alignment boundary. Accordingly, the control unit is further configured to control the first and the second touch strip LED modules to respectively generate a first predetermined lighting line and a second predetermined lighting line in response to the top cover being opened, and the first and the second predetermined lighting lines define a default scan area.

In an exemplary embodiment of the present invention, the control unit is further configured to control the first and the second touch strip LED modules in response to the top cover of the MFP being closed to respectively stop generating the first and the second predetermined lighting lines.

In an exemplary embodiment of the present invention, in a condition of that the top cover is opened, the first touch strip LED module is further configured to generate a first self-set lighting line in response to a first touching event, and the second touch strip LED module is further configured to generate a second self-set lighting line in response to a second touching event, wherein the first and the second self-set lighting lines define a self-set scan area.

In an embodiment of the present invention, the control unit is further configured to control the first and the second touch strip LED modules in response to the top cover of the MFP being closed to respectively stop generating the first and the second self-set lighting lines.

In an exemplary embodiment of the present invention, the MFP may further include a scan module coupled with and controlled by the control unit, and the scan module is configured to perform a first scan task within the default scan area in response to a first scan request.

In an exemplary embodiment of the present invention, the scan module is further configured to perform a second scan task within the self-set scan area in response to a second scan request.

In an exemplary embodiment of the present invention, the MFP may further include a print module coupled with and controlled by the control unit, and the print module is configured to perform a print task in response to a print request.

In an exemplary embodiment of the present invention, the MFP may further include a fax module coupled with and controlled by the control unit, and the fax module is configured to perform a fax task in response to a fax request.

Another exemplary embodiment of the present invention provides an intuitive document alignment method suitable for an MFP. The intuitive document alignment method includes: defining a document alignment original point, a first document alignment boundary which originates at the document alignment original point and extends along a first direction, and a second document alignment boundary which originates at the document alignment original point and extends along a second direction on a scan platform of the MFP, wherein the first and the second direction are perpendicularly intersected; installing a first touch strip LED module on the first document alignment boundary and installing the second touch strip LED module on the second document alignment boundary; and when a top cover of the MFP is opened, controlling the first and the second touch strip LED modules to respectively generate a first predetermined light line and a second predetermined lighting line, wherein the first and the second predetermined lighting lines define a default scan area.

Another exemplary embodiment of the present invention provides an intuitive document alignment method suitable for an MFP. The intuitive document alignment method includes: installing a first touch strip LED module on a first document alignment boundary of a scan platform of the MFP, and installing a second touch strip LED module on a second document alignment boundary of the scan platform of the MFP, wherein the first and the second document alignment boundaries are perpendicularly intersected; and when a top cover of the MFP is opened, controlling the first and the second touch strip LED modules to respectively generate a first predetermined lighting line and a second predetermined lighting line, wherein the first and the second predetermined lighting lines define a default scan area.

In an exemplary embodiment of the present invention, the intersection of the first and the second document alignment boundaries is a document alignment original point of the scan platform of the MFP, the first document alignment boundary originates at the document alignment original point and extends along a first direction, and the second document alignment boundary originates at the document alignment original point and extends along a second direction.

In an exemplary embodiment of the present invention, the intuitive document alignment method may further include: when the top cover of the MFP is closed, controlling the first and the second touch strip LED modules to respectively stop generating the first and the second predetermined lighting lines.

In an exemplary embodiment of the present invention, in a condition of that the top cover of the MFP is opened, the intuitive document alignment method may further include: making the first touch strip LED module generate a first self-set lighting line in response to a first touching event; and making the second touch strip LED module generate a second self-set lighting line in response to a second touching event, wherein the first and the second self-set lighting lines define a self-set scan area.

In an exemplary embodiment of the present invention, the intuitive document alignment method may further include: when the top cover of the MFP is closed, controlling the first and the second touch strip LED modules to respectively stop generating the first and the second self-set lighting lines.

In an embodiment of the present invention, the default scan area corresponds to a standard size document, and the standard size document includes an A3 document, an A4 document, an A5 document, a B4 document, a B5 document, a B6 document or a letter.

In an embodiment of the present invention, the self-set scan area corresponds to a non-standard size document, and the non-standard size document is different from the A3 document, the A4 document, the A5 document, the B4 document, the B5 document, the B6 document or the letter.

From the above, the present invention provides an MFP and an intuitive document alignment method thereof, such that when a user opens the top cover of the MFP, a default scan area is defined by two predetermined lighting lines respectively generated by two installed touch strip LED modules. Accordingly, the user can easily see the correct position for the document once the top cover of the MFP is opened due to the two generated predetermined lighting lines respectively correspond to the length and the width of the document.

Moreover, the two installed touch strip LED modules can further generate two self-set lighting lines to define a self-set scan area in response to the sliding touch, i.e., drag, of users. In other words, the two installed touch strip LED modules allow users to define a scan area for any standard or non-standard size document according to the actual size of the document. Accordingly, the control unit controls the scan module to perform a scan task according to the self-set scan area defined by the users, such that the image obtained by scanning is more conformable to the actual size of the document, so the memory space can be reduced and the scan time can be shorten.

However, the above descriptions and the below embodiments are only used for explanation, and they do not limit the scope of the present invention.

### BRIEF DESCRIPTION OF THE DRAWINGS

The accompanying drawings are included to provide further understanding and are incorporated in and constitute a part of this specification. The drawings illustrate exemplary embodiments and, together with the description, serve to explain the principles of the disclosure.

FIG. 1A is a schematic outside view of a multi-function printer according to an exemplary embodiment of the present invention.

FIG. 1B is a system schematic view of a multi-function printer according to an exemplary embodiment of the present invention.

FIG. 2A is a schematic view of a defined default scan area according to an exemplary embodiment of the present invention.

FIG. 2B is a schematic view of a defined self-set scan area according to an exemplary embodiment of the present invention.

FIG. 2C is a schematic view of performing scan within the defined default scan area according to an exemplary embodiment of the present invention.

FIG. 2D is a schematic view of performing scan within the defined self-set scan area according to an exemplary embodiment of the present invention.

FIG. 3 is a flow chart of the intuitive document alignment method suitable for the multi-function printer according to an exemplary embodiment of the present invention.

### DETAILED DESCRIPTION OF DISCLOSED EMBODIMENTS

Descriptions of the invention are given with reference to the exemplary embodiments illustrated with accompanied drawings, wherein same or similar parts are denoted with same reference numerals. In addition, wherever possible, identical or similar reference numbers stand for identical or similar elements in the figures and the embodiments.

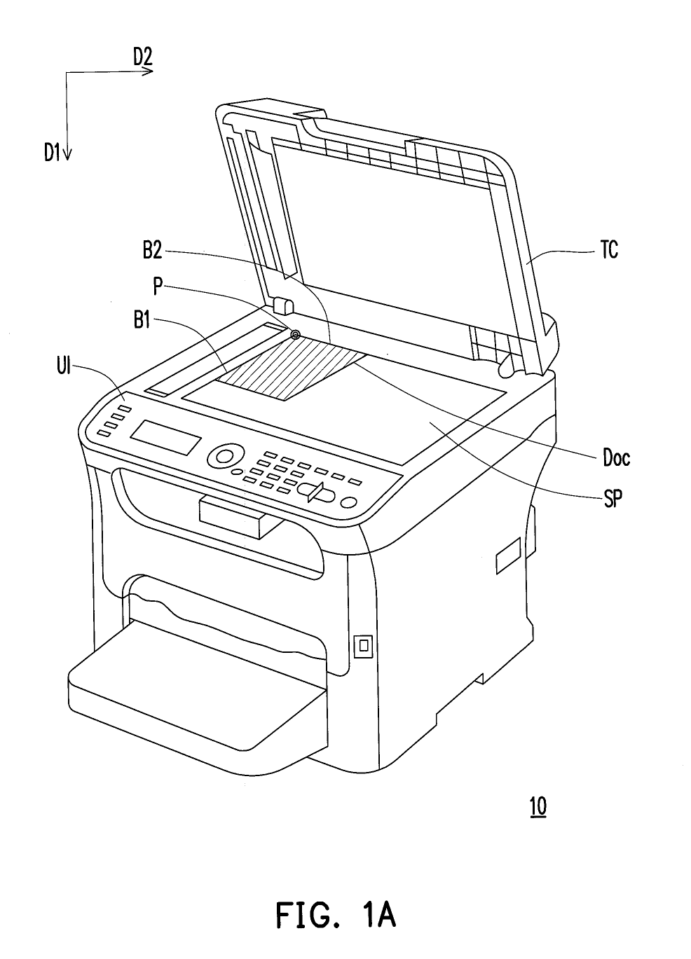

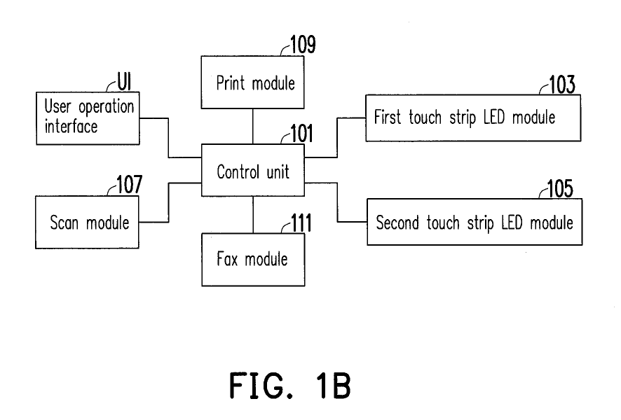

FIG. 1A is a schematic outside view of the multi-function printer (MFP) 10 according to an exemplary embodiment of the present invention, and FIG. 1B is a system schematic view of the MFP 10 according to an exemplary embodiment of the present invention. Referring to FIG. 1A and FIG. 1B, the MFP 10 of the present exemplary embodiment includes a top cover TC, a scan platform SP, a user operation interface UI, a control unit 101, a first touch strip light-emitting diode (LED) module 103, a second touch strip LED module 105, a scan module 107, a print module 109 and a fax module 111.

In the present exemplary embodiment, the document Doc to be scanned or photocopied can be place on the scan (glass) platform SP. Moreover, a user can set the MFP 10 through the user operation interface UI, such as operating mode setting, operating quality setting, paper tray setting, etc., relating to the MFP 10. The control unit 101 is configured to be served as an operation core of the MFP 10, that is to say, to control and manage the overall operation of the MFP 10.

The scan platform SP has a document alignment original point P, a first document alignment boundary B1 which originates at the document alignment original point P and extends along a first direction D1, and a second document alignment boundary B2 which originates at the document alignment original point P and extends along a second direction D2, wherein the first direction D1 and the second direction D2 are perpendicularly intersected. In other words, the first document alignment boundary B1 and the second document alignment boundary B2 are perpendicularly intersected, wherein the first document alignment boundary B1 originates at the document alignment original point P and extends along the first direction D1, and the second document alignment boundary B2 originates at the document alignment original point P and extends along the second direction D2.

The first touch strip LED module 103 is coupled with and controlled by the control unit 101, and is installed on the first document alignment boundary B1 of the scan platform SP. Furthermore, the second touch strip LED module 105 is coupled with and controlled by the control unit 101, and is installed on the second document alignment boundary B2 of the scan platform SP.

The scan module 107 is coupled with and controlled by the control unit 101, and is configured to perform a scan task within a certain scan area in response to a scan request of the user. The print module 109 is coupled with and controlled by the control unit 101, and is configured to perform a print task in response to a print request of the user. The fax module 111 is coupled with and controlled by the control unit 101, and is configured to perform a fax task in response to a fax request of the user. Of course, the functions of the MFP 10 of the present exemplary embodiment are not limited to photocopy, scan and fax. The other modules of functions different from photocopy, scan and fax can also be implemented in the MFP 10 according to the requirement of the actual design/application.

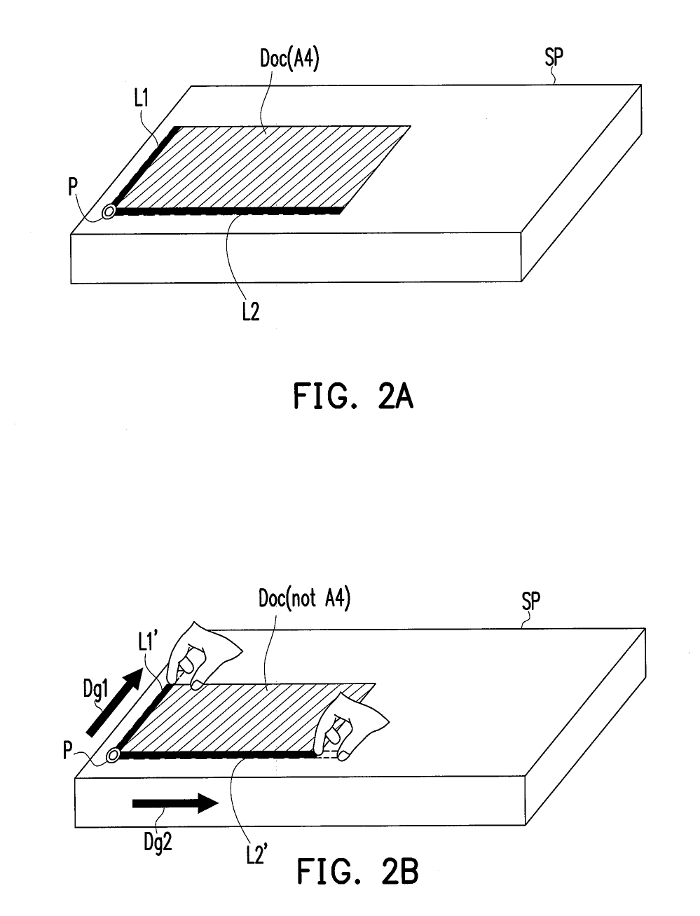

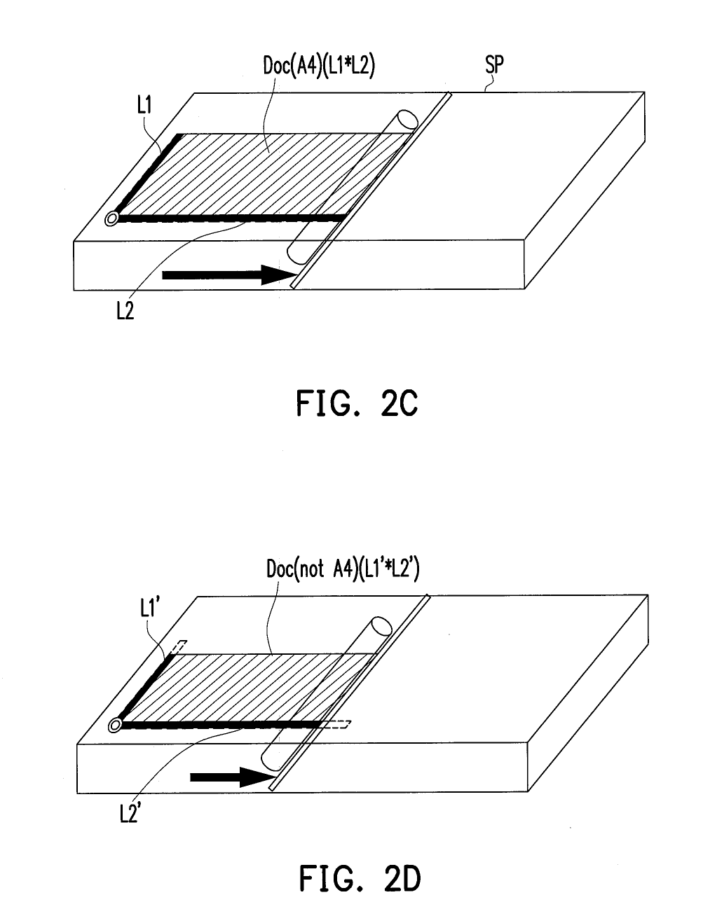

In the present exemplary embodiment, the control unit 101 can control the first and the second touch strip LED modules 103, 105 in response to the top cover TC of the MFP 10 being opened to respectively generate a first predetermined lighting line L1 and a second predetermined lighting line L2, as shown in FIG. 2A. Also, the generated first and second predetermined lighting lines L1, L2 define a default scan area L1*L2. More specifically, the default scan area L1*L2 defined according to the first and the second predetermined lighting lines L1, L2 corresponds to a certain standard size document, for example, an A4 document, but the present invention is not limited thereto. Other standard size document such as an A3 document, an A5 document, a B4 document, a B5 document, a B6 document or a letter can also be applied according to the requirement of the actual design/application.

Furthermore, the control unit 101 controls the first and the second touch strip LED modules 103, 105 in response to the top cover TC of the MFP 10 being closed to respectively stop generating the first and the second predetermined lighting lines L1, L2 in order to avoid affecting the photocopy, scan or fax task. Therefore, if the default scan area L1*L2 defined according to the first and the second predetermined lighting lines L1, L2 meets the user requirement, the control unit 101 controls the scan module 107 accordingly, and makes the scan module 107 perform the scan task only within the defined default scan area L1*L2, as shown in FIG. 2C.

On the other hand, as shown in FIG. 2B, in a condition of that the top cover TC of the MFP 10 is opened, the first touch strip LED module 103 can generate a first self-set lighting line L1′ in response to a first touch event, for example, the sliding touch, i.e., drag direction Dg1, of the finger of the user on the first touch strip LED module 103. Similarly, the second touch strip LED module 105 can also generate a second self-set lighting line L2′ in response to a second touching event, for example, the sliding touch, i.e., drag direction Dg2, of the finger of the user on the second touch strip LED module 105. The first and the second self-set lighting lines L1', L2′ define a self-set scan area L1′*L2′.

In the present exemplary embodiment, the self-set scan area L1′*L2′ defined according to the first and the second self-set lighting lines L1′, L2′ corresponds to a non-standard size document, and the non-standard size document can be different from the A3 document, the A4 document, the A5 document, the B4 document, the B5 document, the B6 document or the letter, but the present invention is not limited thereto. Similarly, the control unit 101 controls the first and the second touch strip LED modules 103, 105 in response to the top cover TC of the MFP 10 being closed to respectively stop generating the first and the second self-set lighting lines L1′, L2′ in order to avoid affecting the photocopy, scan or fax task. Therefore, the control unit 101 controls the scan module 107 according to the self-set scan area L1′*L2′ defined by the user, and makes the scan module 107 perform scan task only within the self-set scan area L1′*L2′ defined by the user, as shown in FIG. 2D.

From the above, when the user intends to use the MFP 10 to perform photocopy, scan or fax task, once the user opens the top cover TC of the MFP 10, the control unit 101 controls the first and the second touch strip LED modules 103, 105 to respectively generate the first and the second predetermined lighting lines L1, L2. Meanwhile, the user can easily see (at glance) the correct position for the document due to the two generated predetermined lighting lines L1, L2 respectively correspond to the length and the width of the A4 document.

In this case, if the size of the document to be photocopied, scanned, or faxed matches the A4 document, the user can place the document to be photocopied, scanned or faxed on the scan platform SP according to the two generated predetermined lighting lines L1, L2. In other words, when opening the top cover TC of the MFP 10, the user only needs to place the document to be photocopied, scanned or faxed on the scan platform SP according to the two generated predetermined lighting lines L1, L2, and does not need to use the scales originally drawn on the two document alignment boundaries B1, B2 of the scan platform SP to find the mark of the correct document size.

Once the user places the document Doc to be photocopied, scanned or faxed on the correct position of the scan platform SP, the user can close the top cover TC of the MFP 10. Meanwhile, the control unit 101 controls the first and the second touch strip LED modules 103, 105 in response to the top cover TC of the MFP 10 being closed to respectively stop generating the first and the second predetermined lighting lines L1, L2 in order to perform the photocopy/scan/fax task within the defined default scan area L1*L2.

On the other hand, if the size of the document to be photocopied, scanned or faxed does not match the A4 document, the user can place the document to be photocopied, scanned or faxed on the scan platform SP according to the two generated predetermined lighting lines L1, L2, and then the user can respectively do the dragging on the first and the second touch strip LED modules 103, 105 to define the scan area matching the document to be photocopied, scanned or fax, for example, L1′*L2′, but the present invention is not limited thereto.

More specifically, the user can perform dragging, starting from the document alignment original point P, on the first touch strip LED module 103 along the first direction D1, so as to define the width matching the document Doc to be photocopied, scanned or faxed, for example, the self-set lighting line L1′, but the present invention is not limited thereto. Next, the user can perform dragging, starting from the document alignment original point P, on the second touch strip LED module 105 along the second direction D2, so as to define the length matching the document Doc to be photocopied, scanned or faxed, for example, the self-set lighting line L2′, but the present invention is not limited thereto. Accordingly, the user can self-define the scan area matching the document Doc to be photocopied, scanned or faxed, for example, L1′*L2′, but the present invention is not limited thereto.

After self-defining the scan area (for example, L1′*L2′, but the present invention is not limited thereto) matching the document Doc to be photocopied, scanned or faxed, the user can close the top cover TC of the MFP 10. Meanwhile, the control unit 101 controls the first and the second touch strip LED modules 103, 105 in response to the top cover TC of the MFP 10 being closed to respectively stop generating the first and the second self-set lighting lines L1′, L2′, and then controls the scan module 107 to perform the photocopy/scan/fax task within the defined self-set scan area L1'*L2′.

It is known that, in the present exemplary embodiment, when the user opens the top cover TC of the MFP 10, a default scan area L1*L2 can be defined by two predetermined lighting lines L1, L2 respectively generated by the two installed touch strip LED modules 103, 105. Accordingly, the user can easily see (at glance) the correct position for the document once the top cover TC of the MFP 10 is opened due to the two generated predetermined lighting lines respectively correspond to the length and the width of the document.

Moreover, the two touch strip LED modules 103, 105 can further generate two self-set lighting lines L1′, L2′ in response to the sliding touch, i.e., drag, of the user to define a self-set scan area L1'*L2′. In other words, the two installed touch strip LED modules allow the user to define a scan area for any standard or non-standard size document according to the actual size of the document. Accordingly, the control unit 101 controls the scan module 107 to perform a scan task according to the self-set scan area defined by the user, such that the image obtained by scanning is more conformable to the actual size of the document, so the memory space can be reduced and the scan time can be shorten.

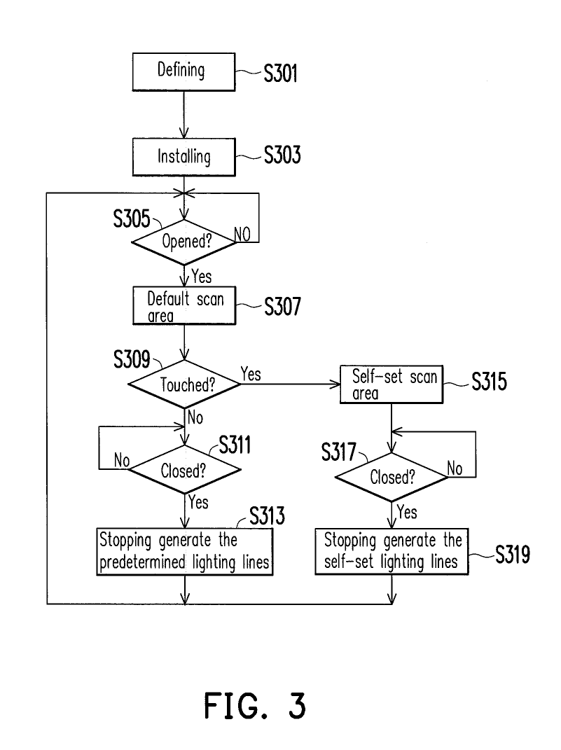

Based on the disclosure/teaching of the above-mentioned exemplary embodiments, FIG. 3 is a flow chart of an intuitive document alignment method suitable for an MFP according to an exemplary embodiment of the present invention. Referring to FIG. 3, in the present exemplary embodiment, the intuitive document alignment method suitable for the MFP may include the following steps.

Defining a document alignment original point, a first document alignment boundary which originates at the document alignment original point and extends along a first direction, and a second document alignment boundary which originates at the document alignment original point and extends along a second direction on a scan platform of the MFP, wherein the first direction and the second direction are perpendicularly intersected (Step S301).

Installing a first touch strip LED module on the first document alignment boundary and installing a second touch strip LED module on the second document alignment boundary (Step S303).

Determining whether the top cover of the MFP is opened (Step S305).

When the top cover of the MFP is determined opened (“Yes”), the first and the second touch strip LED modules are controlled to respectively generate a first predetermined lighting line and a second predetermine lighting line, and the first and the second predetermined lighting lines can define a default scan area (Step S307); otherwise (“No”), determining whether the top cover of the MFP is opened is continued.

After generating the first predetermined lighting line and the second predetermined lighting line to define the default scan area, determining whether the first and the second touch strip LED modules are touched (Step S309). If the first and the second touch strip LED modules are both determined not touched (“No”), it represents that the defined default scan area matches the size of the document to be processed by the user. Accordingly, continuing to determine whether the top cover of the MFP is closed (Step S311). When the top cover of the MFP is determined closed (“Yes”), the first and the second touch strip LED modules are controlled to respectively stop generating the first and the second predetermined lighting lines (Step S313); otherwise (“No”), determining whether the top cover of the MFP is closed is continued.

On the other hand, if the first and the second touch strip LED modules are determined touched (“Yes”), it represents that the defined default scan area does not match the size of the document to be processed by the user. Accordingly, the first touch strip LED module is made to generate a first self-set lighting line in response to a first touching event, and the second touch strip LED module is made to generate a second self-set lighting line in response to a second touching event, wherein the first and the second self-set lighting lines define a self-set scan area (Step S315).

After generating the first and the second self-set lighting lines to define the self-set scan area, determining whether the top cover of the MFP is closed is continued (Step S317). When the top cover of the MFP is determined closed (“Yes”), the first and the second touch strip LED modules are controlled to respectively stop generating the first and the second self-set lighting lines (Step S319); otherwise (“No”), determining whether the top cover of the MFP is closed is continued.

Similarly, the default scan area defined in Step S307 corresponds to a certain standard size document, for example, an A4 document, but the present invention is not limited thereto. Other standard size document such as an A3 document, an A5 document, a B4 document, a B5 document, a B6 document or a letter can also be applied according to the requirement of the actual design/application. Moreover, the self-set scan area defined in Step S315 can also correspond to a non-standard size document, and the non-standard size document can be different from the A3 document, the A4 document, the A5 document, the B4 document, the B5 document, the B6 document or the letter, but the present invention is not limited thereto.

However, it is noticeable that, in the other exemplary embodiments of the present invention, Step S301 is not necessary. Accordingly, Step S303 can be modified as: “the first and the second touch strip LED modules are respectively installed on two perpendicularly intersected (for example, the first and the second) document alignment boundaries of the scan platform of the MFP”. The intersection of the first and the second document alignment boundaries is a document alignment original point of the scan platform of the MFP, the first document alignment boundary originates at the document alignment original point and extends along a first direction, and the second document alignment boundary originates at the document alignment original point and extends along a second direction.

In summary, the present invention provides an MFP and an intuitive document alignment method thereof, such that when a user opens the top cover of the MFP, a default scan area is defined by two predetermined lighting lines respectively generated by two installed touch strip LED modules. Accordingly, the user can easily see the correct position for the document once the top cover of the MFP is opened due to the two generated predetermined lighting lines respectively correspond to the length and the width of the document.

Moreover, the two installed touch strip LED modules can further generate two self-set lighting lines to define a self-set scan area in response to the sliding touch, i.e., drag, from the user. In other words, the two touch strip LED modules allow the user to define a scan area for any standard or non-standard size document according to the actual size of the document. Accordingly, the control unit controls the scan module to perform a scan task according to the self-set scan area defined by the user, such that the image obtained by scanning is more conformable to the actual size of the document, so the memory space can be reduced and the scan time can be shorten.

On the other hand, any technical means of installing adjustable lighting lines in the MFP to define a scan area of any standard or non-standard size document falls in the scope of the present invention. Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions. Any of the embodiments or any of the claims of the invention does not need to achieve all of the advantages or features disclosed by the present invention. Moreover, the abstract and the headings are merely used to aid in searches of patent files and are not intended to limit the scope of the claims of the present invention.

What is claimed is:

1. A multi-function printer (MFP), comprising:
a top cover;
a control unit, configured to be served as an operation core of the MFP;
a scan platform, having a document alignment original point, a first document alignment boundary which originates at the document alignment original point and extends along a first direction, and a second document alignment boundary which originates at the document alignment original point and extends along a second direction, wherein the first direction and the second direction are perpendicularly intersected;
a first touch strip light-emitting diode (LED) module, coupled with and controlled by the control unit, and installed on the first document alignment boundary; and
a second touch strip LED module, coupled with and controlled by the control unit, and installed on the second document alignment boundary,
wherein the control unit is further configured to control the first and the second touch strip LED modules to respectively generate a first predetermined lighting line and a second predetermined lighting line in response to the top cover being opened, and the first and the second predetermined lighting lines define a default scan area.

2. The MFP of claim 1, wherein
in a condition of that the top cover is opened, the first touch strip LED module is further configured to generate a first self-set lighting line in response to a first touching event;
in the condition of that the top cover is opened, the second touch strip LED module is further configured to generate a second self-set lighting line in response to a second touching event; and
the first and the second self-set lighting lines define a self-set scan area.

3. The MFP of claim 2, wherein the control unit is further configured to control the first and the second touch strip LED modules to respectively stop generating the first and the second predetermined or self-set lighting lines in response to the top cover being closed.

4. The MFP of claim 2, further comprising:
a scan module, coupled with and controlled by the control unit, and configured to perform a first scan task within the default scan area in response to a first scan request.

5. The MFP of claim 4, wherein the scan module is further configured to perform a second scan task within the self-set scan area in response to a second scan request.

6. The MFP of claim 2, wherein
the default scan area corresponds to a standard size document, and the standard size document comprises an A3 document, an A4 document, an A5 document, a B4 document, a B5 document, a B6 document or a letter; and
the self-set scan area corresponds to a non-standard size document, and the non-standard size document is different from the A3 document, the A4 document, the A5 document, the B4 document, the B5 document, the B6 document or the letter.

7. The MFP of claim 1, further comprising:
a print module, coupled with and controlled by the control unit, configured to perform a print task in response to a print request.

8. The MFP of claim 1, further comprising:
a fax module, coupled with and controlled by the control unit, configured to perform a fax task in response to a fax request.

9. An intuitive document alignment method, suitable for a multi-function printer (MFP), the intuitive document alignment method comprising:
defining a document alignment original point, a first document alignment boundary which originates at the document alignment original point and extends along a first direction, and a second document alignment boundary which originates at the document alignment original point and extends along a second direction on a scan platform of the MFP, wherein the first direction and the second direction are perpendicularly intersected;
installing a first touch strip light-emitting diode (LED) module on the first document alignment boundary and installing a second touch strip LED module on the second document alignment boundary; and
when a top cover of the MFP is opened, controlling the first and the second touch strip LED modules to respectively generate a first predetermined lighting line and a second predetermined lighting line, wherein the first and the second predetermined lighting lines define a default scan area.

10. The intuitive document alignment method of claim 9, further comprising:
making the first touch strip LED module generate a first self-set lighting line in response to a first touching event in a condition of that the top cover is opened;
making the second touch strip LED module generate a second self-set lighting line in response to a second touching event in the condition of that the top cover is opened; and
the first and the second self-set lighting lines define a self-set scan area.

11. The intuitive document alignment method of claim 10, further comprising:
when the top cover is closed, controlling the first and the second touch strip LED modules to respectively stop generating the first and the second predetermined or self-set lighting lines.

12. The intuitive document alignment method of claim 10, wherein
the default scan area corresponds to a standard size document, and the standard size document comprises an A3 document, an A4 document, an A5 document, a B4 document, a B5 document, a B6 document or a letter; and
the self-set scan area corresponds to a non-standard size document, and the non-standard size document is different from the A3 document, the A4 document, the A5 document, the B4 document, the B5 document, the B6 document or the letter.

13. An intuitive document alignment method, suitable for a multi-function printer (MFP), the intuitive document alignment method comprising:
installing a first touch strip light-emitting diode (LED) module on a first document alignment boundary of a scan platform of the MFP, and installing a second touch strip LED module on a second document alignment boundary of the scan platform of the MFP, wherein the first document alignment boundary and the second document alignment boundary are perpendicularly intersected; and
when a top cover of the MFP is opened, controlling the first and the second touch strip LED modules to respectively generate a first predetermined lighting line and a second predetermined lighting line, wherein the first and the second predetermined lighting lines define a default scan area.

14. The intuitive document alignment method of claim 13, further comprising:
making the first touch strip LED module generate a first self-set lighting line in response to a first touching event in a condition of that the top cover is opened;
making the second touch strip LED module generate a second self-set lighting line in response to a second touching event in the condition of that the top cover is opened; and
the first and the second self-set lighting lines define a self-set scan area.

15. The intuitive document alignment method of claim 14, further comprising:
when the top cover is closed, controlling the first and the second touch strip LED modules to respectively stop generating the first and the second predetermined or self-set lighting lines.

16. The intuitive document alignment method of claim 14, wherein
the default scan area corresponds to a standard size document, and the standard size document comprises an A3 document, an A4 document, an A5 document, a B4 document, a B5 document, a B6 document or a letter; and
the self-set scan area corresponds to a non-standard size document, and the non-standard size document is different from the A3 document, the A4 document, the A5 document, the B4 document, the B5 document, the B6 document or the letter.

17. The intuitive document alignment method of claim 13, wherein
a perpendicular intersection of the first document alignment boundary and the second document alignment boundary is a document alignment original point of the scan platform;
the first document alignment boundary originates at the document alignment original point and extends along a first direction; and
the second document alignment boundary originates at the document alignment original point and extends along a second direction.

18. A multi-function printer (MFP), comprising:
a top cover;
a control unit, configured to be served as an operation core of the MFP;
a scan platform, having a first document alignment boundary and a second document alignment boundary which are perpendicularly intersected;
a first touch strip light-emitting diode (LED) module, coupled with and controlled by the control unit, and installed on the first document alignment boundary; and
a second touch strip LED module, coupled with and controlled by the control unit, and installed on the second document alignment boundary,
wherein the control unit is further configured to control the first and the second touch strip LED modules in response to the top cover being opened to respectively generate a first predetermined lighting line and a second predetermined lighting line, wherein the first and the second predetermined lighting lines define a default scan area.

19. The MFP of claim 18, wherein
in a condition of that the top cover is opened, the first touch strip LED module is further configured to generate a first self-set lighting line in response to a first touching event;
in the condition of that the top cover is opened, the second touch strip LED module is further configured to generate a second self-set lighting line in response to a second touching event; and
the first and the second self-set lighting lines define a self-set scan area.

20. The MFP of claim 19, wherein the control unit is further configured to control the first and the second touch strip LED modules in response to the top cover being closed to respectively stop generating the first and the second predetermined or self-set lighting lines.

21. The MFP of claim 19, further comprising:
a scan module, coupled with and controlled by the control unit, and configured to perform a first scan task within the default scan area in response to a first scan request;
a print module, coupled with and controlled by the control unit, configured to perform a print task in response to a print request; and
a fax module, coupled with and controlled by the control unit, configured to perform a fax task in response to a fax request.

22. The MFP of claim 21, wherein the scan module is further configured to perform a second scan task within the self-set scan area in response to a second scan request.

23. The MFP of claim 19, wherein
the default scan area corresponds to a standard size document, and the standard size document comprises an A3 document, an A4 document, an A5 document, a B4 document, a B5 document, a B6 document or a letter; and
the self-set scan area corresponds to a non-standard size document, and the non-standard size document is different from the A3 document, the A4 document, the A5 document, the B4 document, the B5 document, the B6 document or the letter.

24. The multi-function printer of claim 18, wherein
a perpendicular intersection of the first document alignment boundary and the second document alignment boundary is a document alignment original point of the scan platform;
the first document alignment boundary originates at the document alignment original point and extends along a first direction; and
the second document alignment boundary originates at the document alignment original point and extends along a second direction.
